(19) United States
(12) Patent Application Publication
(10) Pub. No.: US 2023/0401038 A1
(43) Pub. Date: Dec. 14, 2023

(54) SYSTEM AND METHOD FOR OPTIMIZED MODERNIZATION OF APPLICATIONS

(71) Applicant: Cognizant Technology Solutions India Pvt. Ltd., Chennai (IN)

(72) Inventors: Madhu Rajagopalan, Chennai (IN); Surendranathan Ardhanari, Chennai (IN); Senthilkumar Chinnusamy, Coimbatore (IN); Trichur Krishnan Narayanan, Chennai (IN)

(21) Appl. No.: 17/985,458

(22) Filed: Nov. 11, 2022

(30) Foreign Application Priority Data
Jun. 13, 2022 (IN) 202241033762

(51) Int. Cl. G06F 8/10; G06F 8/60; G06Q 30/06; G06F 3/0482

(52) U.S. Cl. CPC G06F 8/10; G06F 3/0482; G06Q 30/0631; G06F 8/60

(57) ABSTRACT

A system and a method for optimized modernization of applications is provided. Pre-defined categories of application modernization and technology stacks are received as a query. The pre-defined categories of application modernization and technology stacks are rendered via a user interface (UI) based on a first set of pre-defined rules. Further, application modernization identifiers associated with the query are determined. A compatibility check is carried out between the identifiers based on a pre-defined compatibility rule. Further, a solution for application modernization is recommended based on a second set of pre-defined rules by analyzing the identifiers. Lastly, a Modernization Acceleration Kit (MAK) associated with the identifiers is generated based on the recommended solution for implementation of the recommended solution for optimized modernization of the application.

### FIELD OF THE INVENTION

The present invention relates generally to the field of application modernization. More particularly, the present invention relates to a system and a method for an optimized modernization of applications.

### BACKGROUND OF THE INVENTION

Various organizations are laying great emphasis on modernization of applications managed by them. Modernization of applications relate to migration, rebuilding or updating of applications operating on outdated technologies in the organizations, to latest and new technology. Modernization of applications increases overall efficiency of the organization's operations. However, modernization of the applications is a technology intensive process and requires various techniques for carrying out the said process. The existing techniques used for modernization of applications are associated with certain drawbacks, which makes the overall process less efficient.

Typically, the drawbacks associated with the existing application modernization techniques include inaccurate manual application of techniques, non-unification of various techniques and the techniques existing as single-point solution. Further, existing applications' modernization techniques are subjective and selective to the expertise of the Subject Matter Expert (SME), which causes SME dependency and overhead to any modernization query from the client. Further, SMEs may be unaware of cross-stack impact of one technology on the other. Further, existing techniques do not provide clarity on possible solutions and updates available across multiple teams in the organization. Also, existing techniques are associated with different technology stack affiliations based on primarily a focus on migration. Furthermore, SMEs may not be up to date with the latest technology solutions for modernization of applications and may provide inadequate solutions.

In light of the aforementioned drawbacks, there is a need for a system and a method which provides for optimized modernization of applications. There is a need for a system and a method which provides for modernization of applications with minimum or without any human intervention. Further, there is a need for a system and a method which provides for unification of techniques used for modernizing of the applications. Furthermore, there is a need for a system and a method which provides for a robust modernization of applications, which caters to user's needs and requirements.

### SUMMARY OF THE INVENTION

In various embodiments of the present invention, a system for optimized modernization of applications is provided. The system comprises a memory storing programing instructions, a processor executing the program instructions stored in the memory and an application modernization engine executed by the processor. The application modernization engine is configured to receive one or more pre-defined categories of application modernization and technology stacks as a query. The pre-defined categories of application modernization and technology stacks are rendered via a user interface (UI) based on a first set of pre-defined rules. Further, the application modernization engine is configured to determine application modernization identifiers associated with the query. A compatibility check is carried out between the identifiers based on a pre-defined compatibility rule. Further, the application modernization engine is configured to recommend a solution for application modernization based on a second set of pre-defined rules by analyzing the identifiers. Lastly, the application modernization engine is configured to generate a Modernization Acceleration Kit (MAK) associated with the identifiers based on the recommended solution for implementation of the recommended solution for optimized modernization of the application.

In various embodiments of the present invention, method for optimized modernization of applications is provided. The method comprises receiving, via a processor, one or more pre-defined categories of application modernization and technology stacks as a query. The pre-defined categories of application modernization and technology stacks are rendered via a user interface (UI) based on a first set of pre-defined rules. The method further comprises determining, via the processor, application modernization identifiers associated with the query. A compatibility check is carried out between the identifiers based on a pre-defined compatibility rule. The method further comprises recommending, via the processor, a solution for application modernization based on a second set of pre-defined rules by analyzing the identifiers. Lastly, the method comprises generating, via the processor, a Modernization Acceleration Kit (MAK) associated with the identifiers based on the recommended solution for implementation of the recommended solution for optimized modernization of the application.

In various embodiments of the present invention, a computer program product is provided. The computer program product comprises a non-transitory computer-readable medium having computer program code stored thereon, the computer-readable program code comprising instructions that, when executed by a processor, causes the processor to receive one or more pre-defined categories of application modernization and technology stacks as a query. The pre-defined categories of application modernization and technology stacks are rendered via a user interface (UI) based on a first set of pre-defined rules. Further, application modernization identifiers associated with the query are determined. A compatibility check is carried out between the identifiers based on a pre-defined compatibility rule. Further, a solution for application modernization is recommended based on a second set of pre-defined rules by analyzing the identifiers. Lastly, a Modernization Acceleration Kit (MAK) associated with the identifiers is generated based on the recommended solution for implementation of the recommended solution for optimized modernization of the application.

### BRIEF DESCRIPTION OF THE ACCOMPANYING DRAWINGS

The present invention is described by way of embodiments illustrated in the accompanying drawings wherein:

FIG. 1 is a detailed block diagram of a system for optimized modernization of applications, in accordance with an embodiment of the present invention;

FIG. 2 illustrates a screenshot of a User Interface (UI) depicting pre-defined categories of application modernization, in accordance with an embodiment of the present invention;

FIG. 3 illustrates a screenshot of a UI depicting a source technology selection, in accordance with an embodiment of the present invention;

FIGS. 4 and 4A illustrate a screenshot of a UI depicting a target technology selection, in accordance with an embodiment of the present invention;

FIGS. 5A to 5D illustrate screenshots of a UI depicting recommended solutions rendered on UI, in accordance with an embodiment of the present invention;

FIG. 6 illustrates a screenshot of a UI depicting a Modernization Acceleration Kit (MAK) generated based on a summary of a recommended solution, in accordance with an embodiment of the present invention;

FIG. 7 illustrates a screenshot of a UI depicting rendering of add-on MAKs on the UI based on pre-defined questions, in accordance with an embodiment of the present invention;

FIG. 8 illustrates a screenshot of a UI depicting options to navigate across all relevant technology stacks to assemble associated solutions dynamically, in accordance with an embodiment of the present invention;

FIG. 9 illustrates a screenshot of a UI depicting a feedback form, in accordance with an embodiment of the present invention;

FIGS. 10 and 10A illustrate a flowchart depicting a method for optimized modernization of applications, in accordance with an embodiment of the present invention; and

FIG. 11 illustrates an exemplary computer system in which various embodiments of the present invention may be implemented.

### DETAILED DESCRIPTION OF THE INVENTION

The present invention discloses a system and a method which provides for optimized modernization of applications. The present invention provides for a unified, robust and efficient applications' modernization platform with minimum or no human intervention. The present invention provides for determining a cross-stack impact of one technology on the other while carrying out modernization of the applications. Further, the present invention provides for modernization of applications, which caters to client's needs and requirements by automatically recommending contextual application modernization solutions. Furthermore, the present invention provides for rendering a user interface (UI) for dynamically recommending applications modernization solutions to the users. Yet further, the present invention provides for a feedback-based mechanism for improving the application modernization solutions.

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the scope of the invention. The terminology and phraseology used herein is for the purpose of describing exemplary embodiments and should not be considered limiting. Thus, the present invention is to be accorded the widest scope encompassing numerous alternatives, modifications and equivalents consistent with the principles and features disclosed herein. For purposes of clarity, details relating to technical material that is known in the technical fields related to the invention have been briefly described or omitted so as not to unnecessarily obscure the present invention.

The present invention would now be discussed in context of embodiments as illustrated in the accompanying drawings.

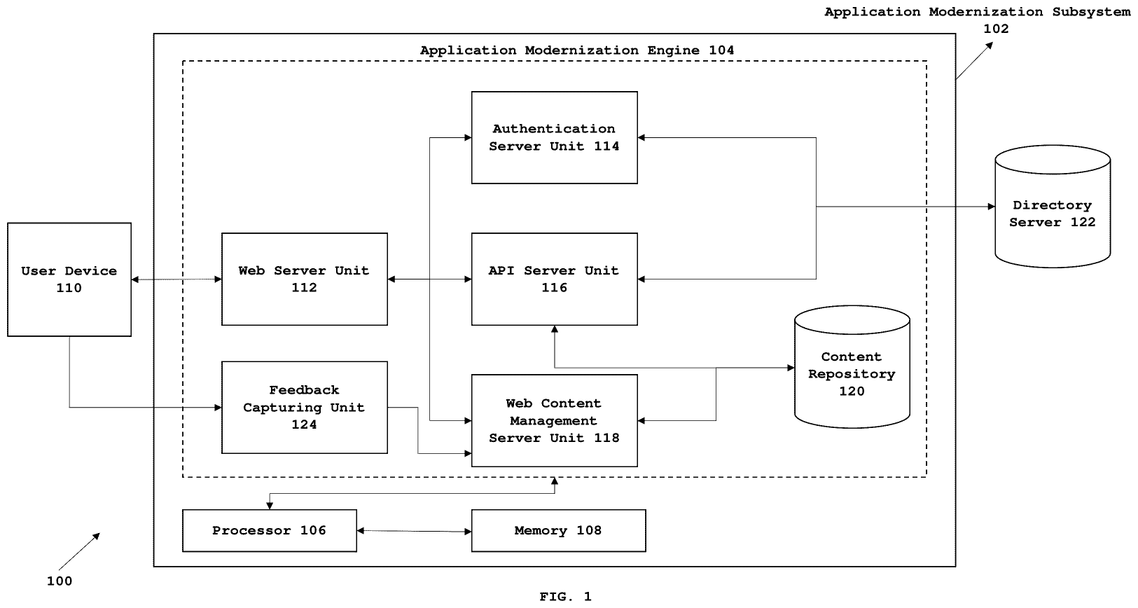

FIG. 1 is a detailed block diagram of a system 100 for optimized modernization of applications, in accordance with various embodiments of the present invention. Referring to FIG. 1, in an embodiment of the present invention, the system 100 comprises an application modernization subsystem 102, a user device 110 and a directory server 122. The user device 110 and the directory server 122 are connected to the subsystem 102 via a communication channel (not shown). The communication channel (not shown) may include, but is not limited to, a physical transmission medium, such as, a wire, or a logical connection over a multiplexed medium, such as, a radio channel in telecommunications and computer networking. The examples of radio channel in telecommunications and computer networking may include, but are not limited to, a local area network (LAN), a metropolitan area network (MAN) and a wide area network (WAN).

The subsystem 102 is configured with a built-in-mechanism for carrying out optimized modernization of applications by automatically recommending application modernization solutions. Further, the subsystem 102 is capable of being operated as a stand-alone entity. The subsystem 102 is a self-optimizing and an open architecture system. The subsystem 102 dynamically provides solution recommendations and solution summary for application modernization solutions.

In an embodiment of the present invention, the subsystem 102 comprises an application modernization engine 104 (the engine 104), a processor 106 and a memory 108. The engine 104 is a rule-based engine, which is scalable, integrable and operable with other technology platforms. In various embodiments of the present invention, the engine 104 has multiple units, which work in conjunction with each other for providing optimized modernization of applications. The various units of the engine 104 are operated via the processor 106 specifically programmed to execute instructions stored in the memory 108 for executing respective functionalities of the units of the engine 104 in accordance with various embodiments of the present invention.

In another embodiment of the present invention, the subsystem 102 may be implemented in a cloud computing architecture in which data, applications, services, and other resources are stored and delivered through shared data-centers. In an exemplary embodiment of the present invention, the functionalities of the subsystem 102 are delivered to a user as Software as a Service (SaaS) or a Platform as a Service (Paas) over a communication network.

In another embodiment of the present invention, the subsystem 102 may be implemented as a client-server architecture. In this embodiment of the present invention, a client terminal accesses a server hosting the subsystem 102 over a communication network. The client terminals may include but are not limited to a computer, a tablet, or any other wired or wireless terminal. The server may be a centralized or a decentralized server.

In an embodiment of the present invention, the engine 104 comprises a web server unit 112, an authentication server unit 114, an Application Programing Interface (API) server unit 116, a web content management server unit 118, a content repository 120 and a feedback capturing unit 124.

In operation, in an embodiment of the present invention, an input is provided via the user device 110 in the form of a query associated with application modernization. In an embodiment of the present invention, the web server unit 112 is configured to communicate with the authentication server unit 114 prior to receiving query, which provides an authentication token to the user device 110 for accessing and communicating with the engine 104 for carrying out the application modernization process. In an exemplary embodiment of the present invention, the authentication server unit 114 operates on OAuth® software, thereby providing a multifactor authentication. The authentication server unit 114 is configured to further communicate with the directory server 122, which stores and maintains multiple users' data, which is accessed by the authentication server unit 114 for authorizing the user device 110 to access the engine 104. In an exemplary embodiment of the present invention, the directory server 122 operates on a Lightweight Directory Access Protocol (LDAP).

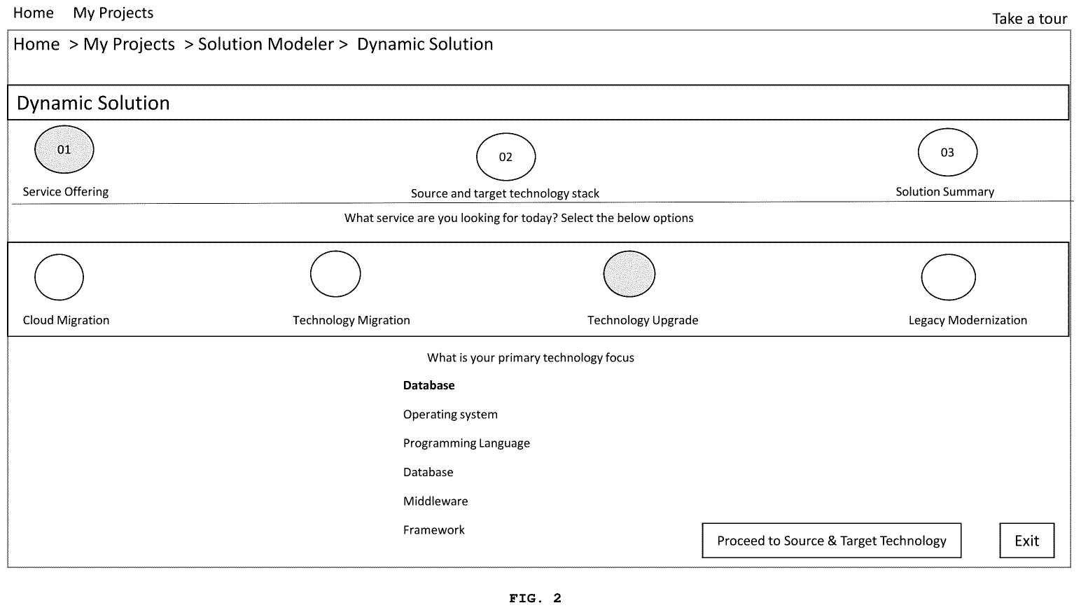

In an embodiment of the present invention, the user device 110 is configured to communicate with the web server unit 112 present in the engine 104. The web server unit 112 is configured to render a dynamic UI on the user device 110, which provides a dashboard for capturing the query on the user device 110. The dashboard renders, on the UI, one or more pre-defined categories of application modernization and a list of technology stacks (tech stacks) based on a first set of pre-defined rules, for recommending appropriate application modernization solution. The pre-defined categories of application modernization include, but are not limited to, cloud migration, technology migration, technology upgrade and legacy application modernization, as illustrated in FIG. 2. One of the categories from the four categories is selected at a time for application modernization according to users' needs and requirements. In an exemplary embodiment of the present invention, the web server unit 112 operates on at least Apache® software and Nginx® software. Further, the dashboard provides the list of tech stacks on the UI from which type of technology entity is selected for which modernization is required, as illustrated in FIG. 2. The tech stack includes, but is not limited to, operating system, database, programing language, framework, middleware and scheduler. One of the technology stacks is selected on the UI. The web server unit 112 is configured to receive the selected pre-defined category and the technology stack, as part of the query from the user device 110 via the UI provided on the user device 110. Further, the user device 110 includes a computer, a laptop or the like, which is capable of rendering a UI.

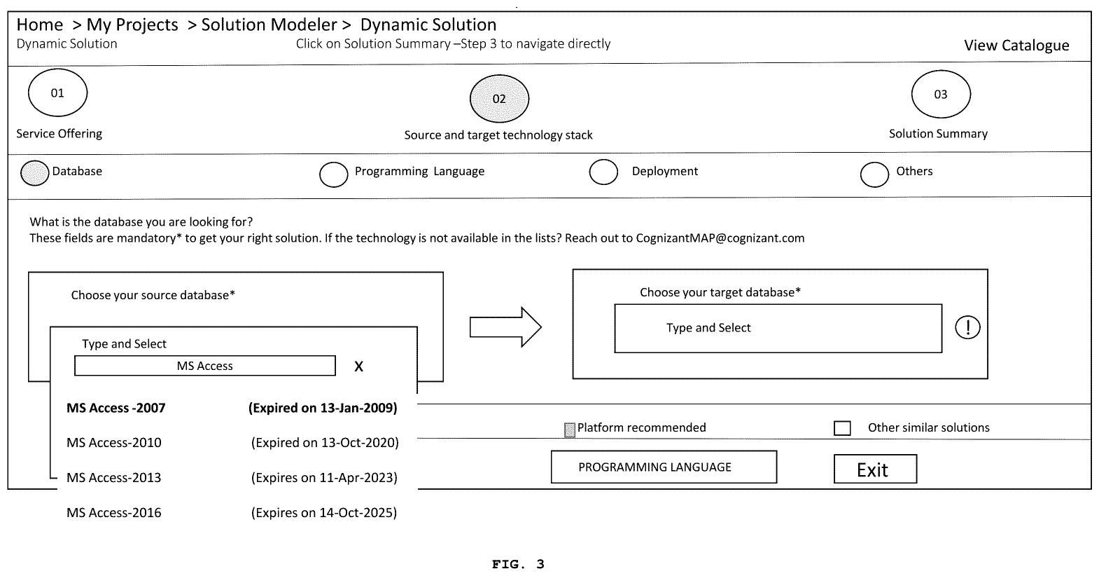

In an embodiment of the present invention, the web server unit 112 is configured to transmit the received query to the API server unit 116, which analyzes and processes the query. In an exemplary embodiment of the present invention, the API server unit 116 operates as a Kestrel server and a Representational State Transfer Application Programming Interface (REST API). In an embodiment of the present invention, the query is processed by the API server unit 116 for determining identifiers associated with the query. In an exemplary embodiment of the present invention, the query includes two identifiers for application modernization associated with user's needs and requirements. The two determined identifiers comprise a source technology selection and a target technology selection. The source technology selection represents technology of an existing application and the target technology selection represents a new technology to which the existing application is to be migrated, as illustrated in FIG. 3. For example, the source technology selection may relate to MS Access database management system and the target technology selection may relate to MySQL database management system.

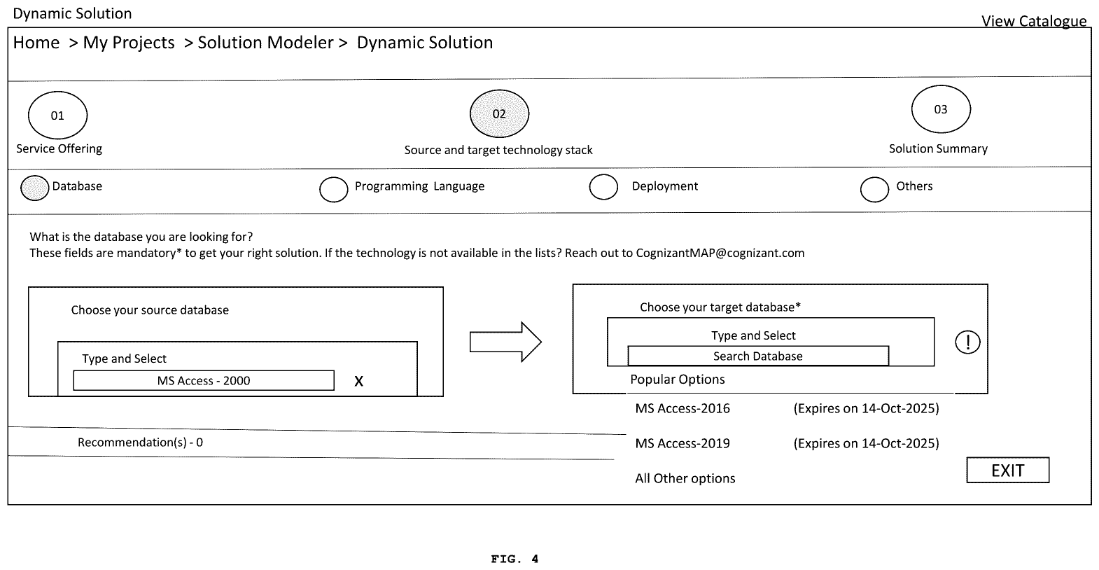

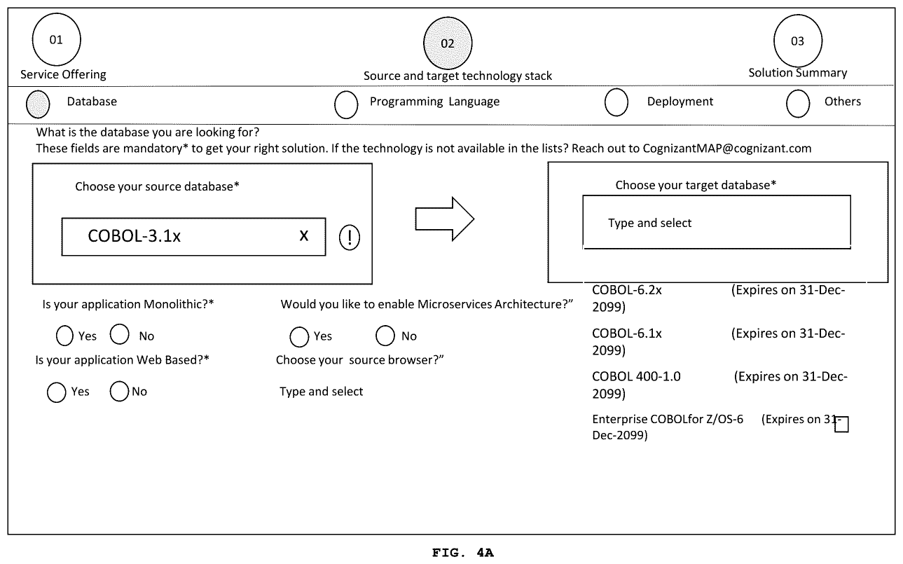

In an embodiment of the present invention, the API server unit 112 is configured to invoke the content repository 120. The content repository 120 is configured to send a list of source technology and a list of target technology via the web content management server unit 118 for selection to the web server unit 112. The received lists are rendered via the UI on the user device 110 based on an authentication process carried out by the directory server 122. In an exemplary embodiment of the present invention, the authentication process includes a single LDAP authentication. In an exemplary embodiment of the present invention, the content repository 120 comprises pre-stored solution documents data, images data, videos data, solution blueprints data, etc., which are accumulated based on various empirical studies. The content repository 120 is updated with the solution data regularly. In an exemplary embodiment of the present invention, the web content management server unit 118 operates on Drupal® and may be deployed at least on Azure®, or on-premise. Further, Drupal® is not exposed for external usage and is accessible via .Net API® thereby ensuring secure access and protection. The source technology is selected from the list of source technology tags rendered on the UI, as illustrated in FIG. 3. Further, the source technology tags are rendered along with their different versions and expiry dates. Furthermore, the target technology is selected from a list of target technology tags rendered on the UI, as illustrated in FIG. 4 and FIG. 4A. The target technology tags are rendered along with their different versions and expiry dates and most popular and latest target technology tags are rendered separately. In an embodiment of the present invention, prior to selection of the target technology, a compatibility check is carried out between the identifiers i.e. between the source technology and the target technology based on a pre-defined compatibility rule. For example, if MS Access v12 has been selected as a source technology, and MongoDB v6.2.1 has been selected as a target technology, then programming languages that are compatible with MongoDB v6.2.1 are selected as target technology. The target technologies rendered on the UI fulfill at least the compatibility criterion based on the pre-defined compatibility rule. The compatibility criterion includes but is not limited to, the target technology must not be expired and the target technology must be compatible with previously selected target technologies in order to ensure a compatible environment.

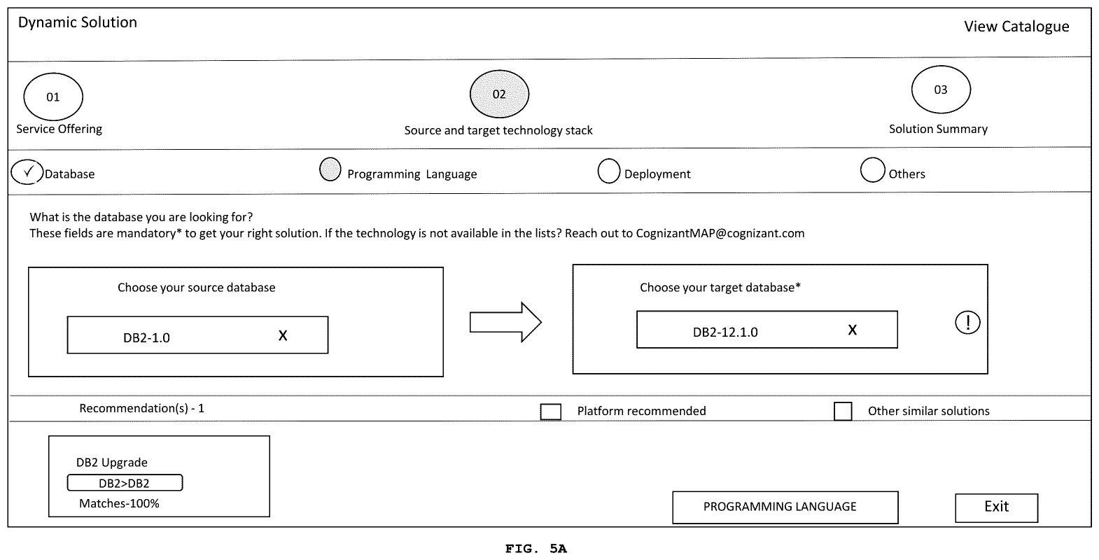

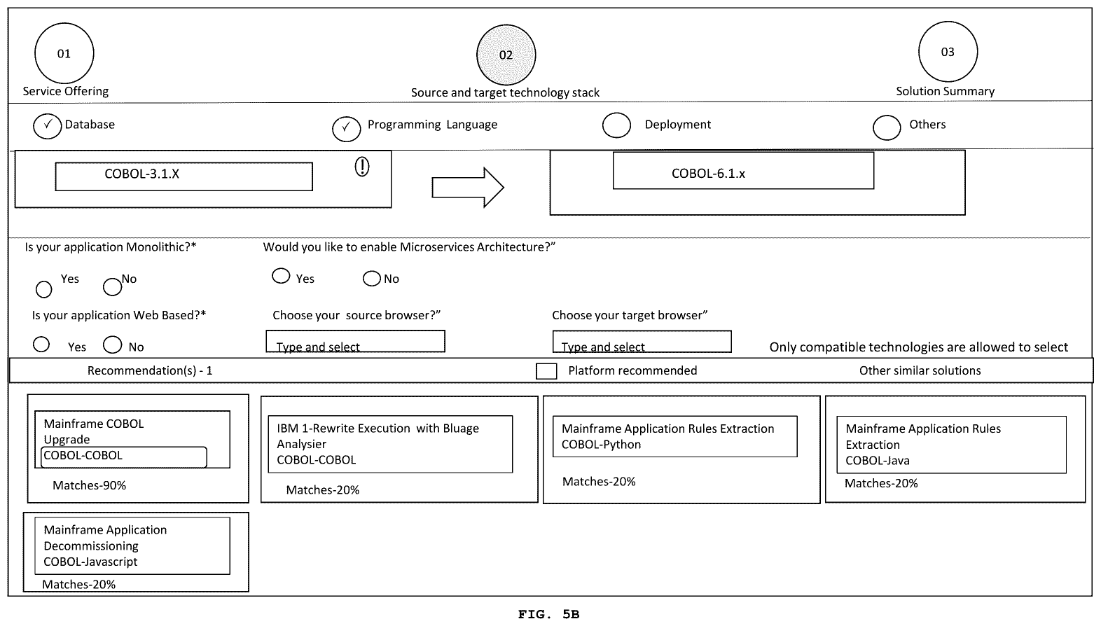

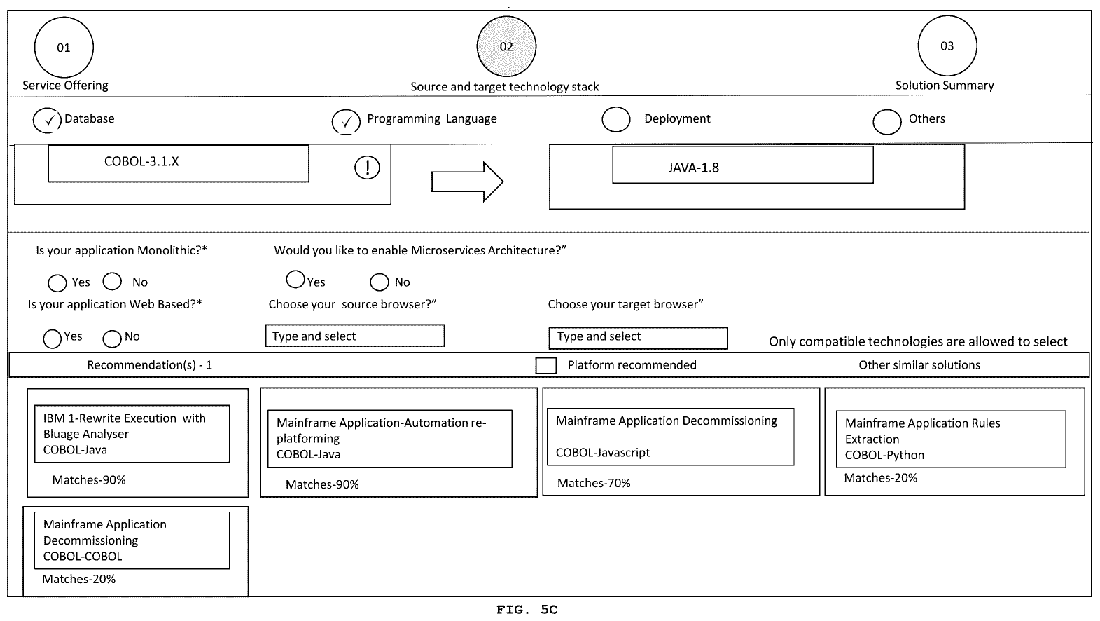

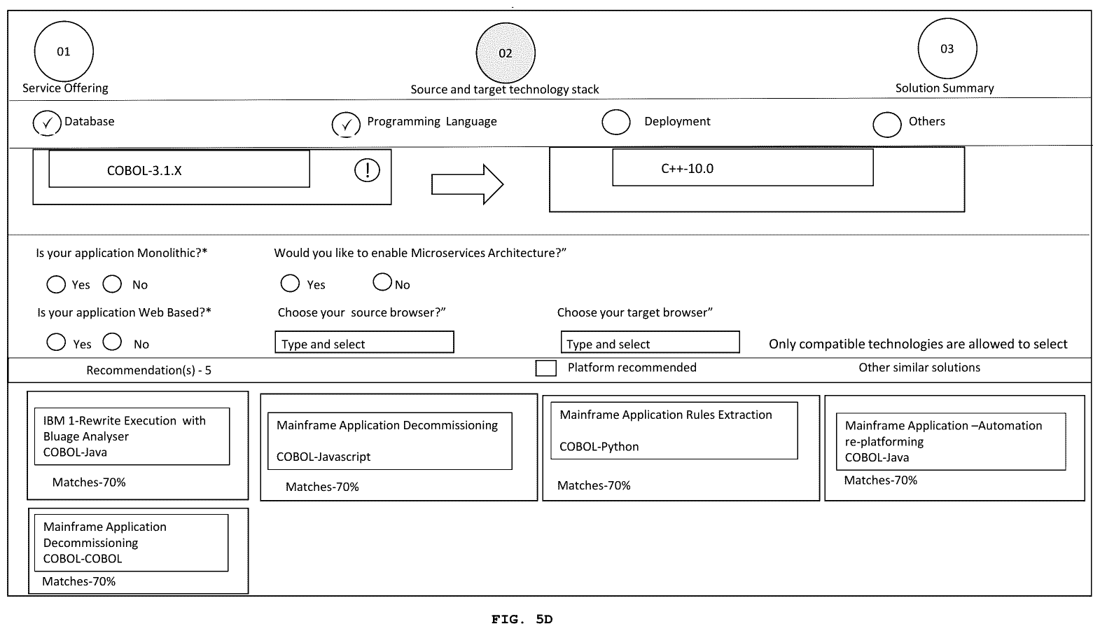

In an embodiment of the present invention, the selected identifiers i.e. the source technology and the target technology are further processed by the application modernization engine 104. The application modernization engine 104 is configured to recommend a solution for application modernization based on a second set of pre-defined rules by analyzing the processed identifiers i.e. the source technology and the target technology. The recommended solution is fetched by the web content management server unit 118 from the content repository 120 for rendering on the user device 110. The recommended solution is the application modernization solution, which may be exact or similar solution with respect to the target technology. Further, the recommended solution is provided along with a match percentage, which represents a percentage value of match for the recommended solution with respect to the source technology tag and the target technology tag. The recommended solution is rendered on the UI, as illustrated in FIGS. 5A, 5B, 5C and 5D. In an embodiment of the present invention, the second set of pre-defined rules identifies the modernization technologies based on technology equivalence and technology compatibility of the modernization technology with respect to an existing application technology. The technology equivalence is determined based on operational time period, generation and capabilities of a similar technology by using an equivalence relation incorporated in schema. Advantageously, technology equivalence aids in recommending similar Modernization Acceleration Kit (MAKs) as solution approach and leveraging tools for equivalent technology transformations. Further, the technology compatibility is determined based on the compatibility relation of the modernization technology with respect to previously selected target technologies across one or more technology stacks by using the compatibility relation incorporated in the schema. For example, if a programming language modernization from Visual Basic v6 (source technology) to Java 7.1 (target technology) is selected, then the application modernization engine 104 is configured to recommend a suitable solution as MongoDB v6.2.1 and one or more similar solutions as well, which is rendered on the UI. The compatibility relation enables the subsystem 102 to dynamically provide contextual solutions that are potentially relevant with user needs and requirements. The recommended solution may relate to application migration, database (DB) migration, operating system (OS) migration, programming language update, framework migration, hardware modifications, etc. Further, in an event if a DB migration is required, then the recommended solution also suggests an option to use a particular programing language for efficient migration.

In an embodiment of the present invention, the content repository 120 is configured with a first version type i.e. a lighter version of metadata related to various technologies, which is processed by the web content management server unit 118 for recommending the solution via the UI based on the analyzed source technology and the target technology. Further, a My SQL DB (not shown) associated with the engine 104 is configured with a second version type i.e. a larger version of the metadata, which is further processed for recommending the solution via the UI based on the analyzed source technology and the target technology. The metadata associated with various technologies comprise various technology stacks, technology versions with end-of-support data, etc.

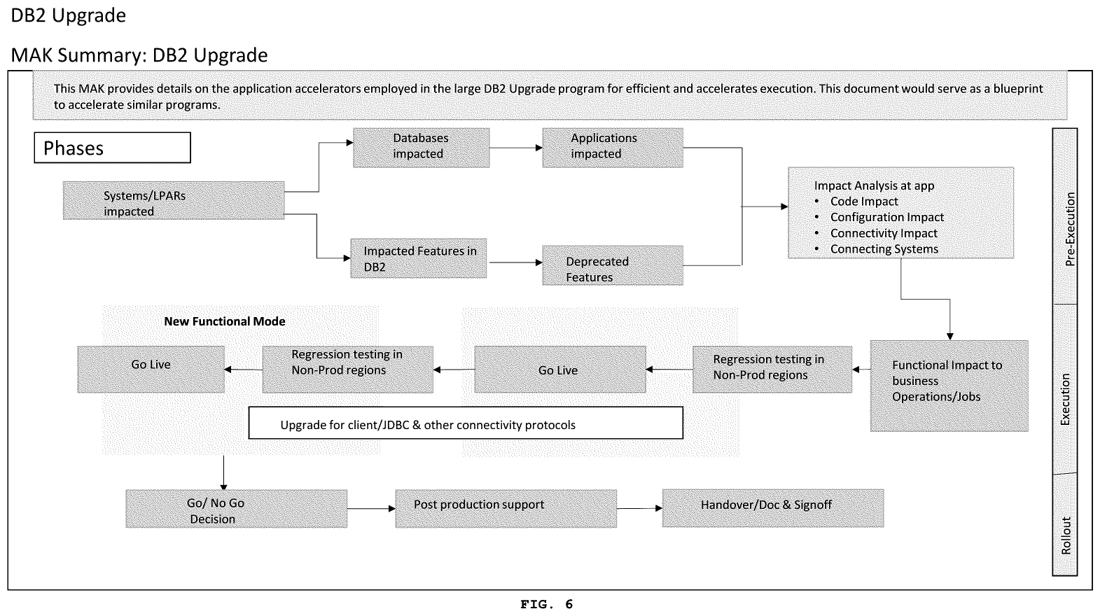

In an embodiment of the present invention, the web content management server unit 118 is configured to render a summary of the recommended solution based on a third set of pre-defined rules which is rendered via the UI, as illustrated in FIG. 6. The summary of the recommended solution comprises brief description of the recommended solution, modernization phases, tools used, modifications made to the existing application during the modernization process such as, impact on the system, impact on databases, impact on features in database, impact on application, conversion mode, new function mode, application migration steps, etc. Further, each recommended solution is associated with a summary provided by the web content management server unit 118.

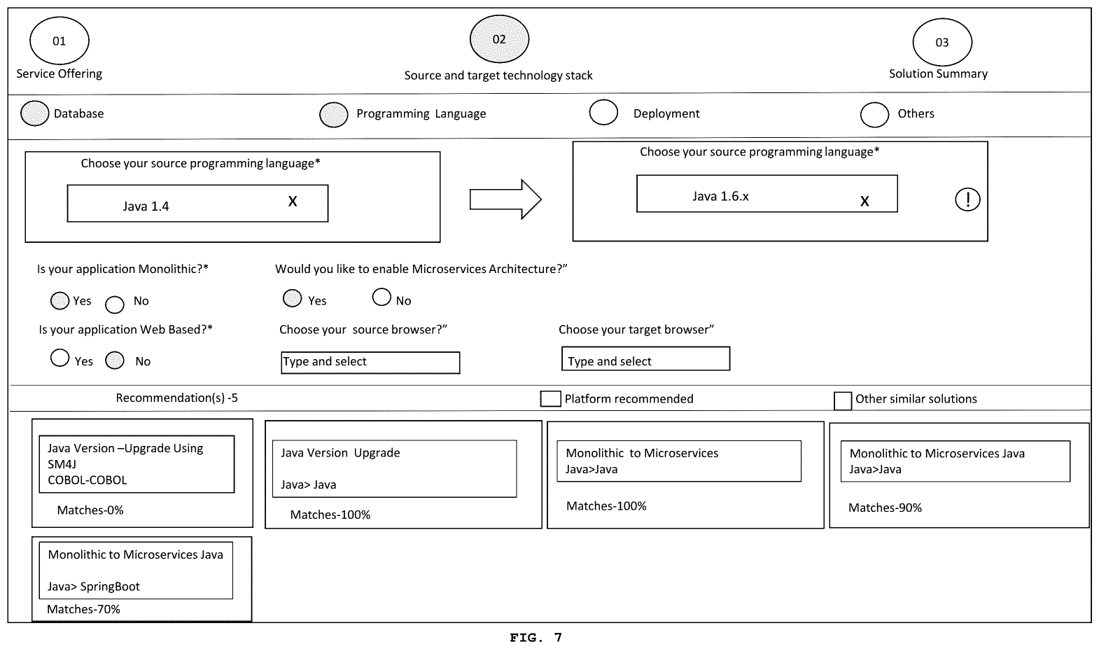

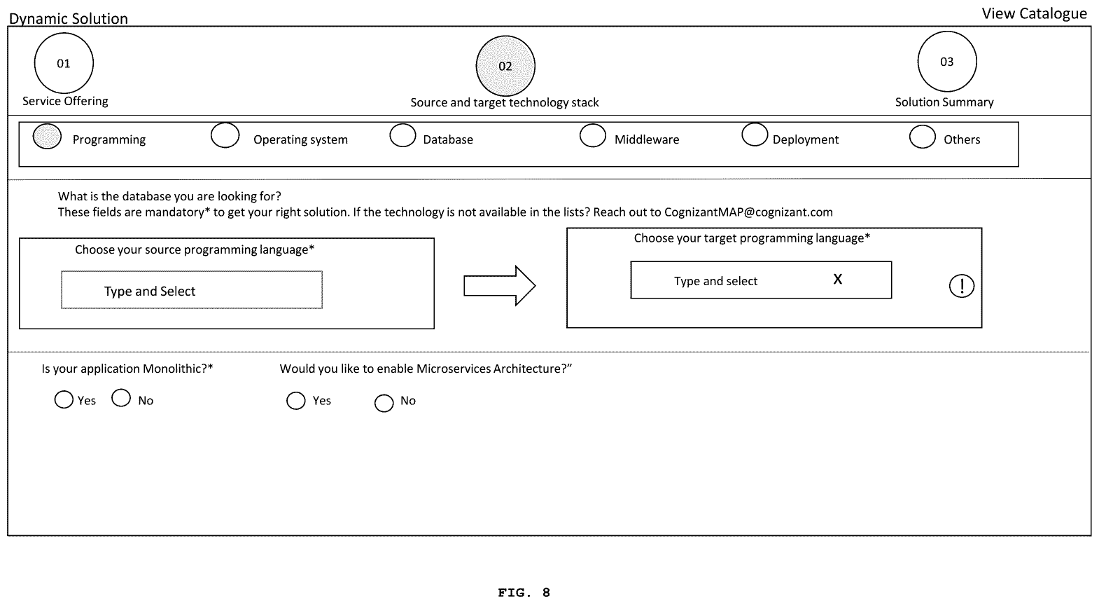

In an embodiment of the present invention, the web content management server unit 118 in communication with the content repository 120 provides for assembling and generating a downloadable Modernization Acceleration Kit (MAK) associated with the identifiers, based on a fourth set of pre-defined rules. The MAK comprises recommended solution summary, solution templates, details about ‘out of the box’ tools or accelerators and references. The MAK also comprises details on additional solution recommendations such as pre-requisites and supplementary technology components and solutions that need to be considered. Further, the MAK is contextualized based on constraints and customized to generate a solution blueprint for implementation. In an embodiment of the present invention, the web content management server unit 118 in communication with the content repository 120 renders add-on MAKs via the UI based on one or more pre-defined questions, as illustrated in FIG. 7. In another embodiment of the present invention, the web content management server unit 118 in communication with the content repository 120 provides an option to navigate across all relevant technology stacks to assemble associated solutions dynamically, as illustrated in FIG. 8. FIG. 8 depicts screenshot of the UI that provides tech stacks with respect to programming language modernization and FIG. 5C depicts screenshot of the UI tech stacks with respect to database modernization.

In an embodiment of the present invention, in the event the web content management server unit 118 in communication with the content repository 120 is not able to recommend a solution for the selected source target technology and the target technology, then the web content management server unit 118 creates a ‘no solution’ entry in the content repository 120 and communicates the selected source target technology and the target technology to a Subject Matter Expert (SME). An SME analyzes the selected source target technology and the target technology for recommending an appropriate solution. The solution recommended by the SME is rendered via the UI on the user device 110. The solution recommended by the SME is communicated to the content repository 120 for updating the content repository 120 with the SME recommended solution.

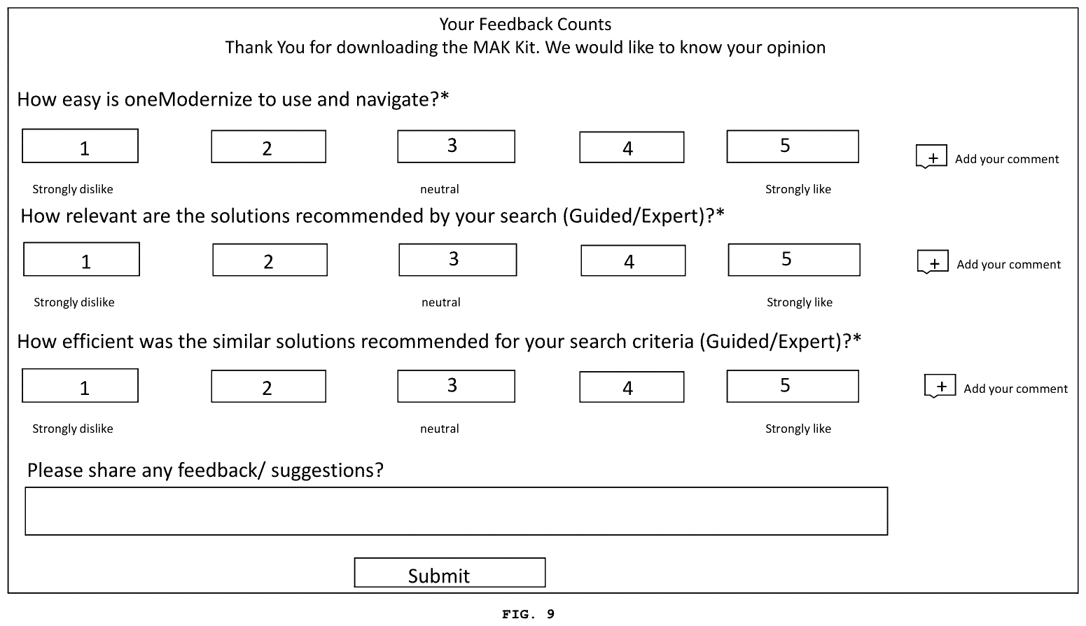

In an embodiment of the present invention, feedback is captured on the effectiveness of the recommended solution via the user device 110, as illustrated in FIG. 9, which is communicated to the feedback capturing unit 124. The feedback capturing unit 124 is configured to communicate to the web content management server unit 118 for transmitting the feedback for storage in the content repository 120, such that the web content management server unit 118 regularly provides efficient solution recommendation.

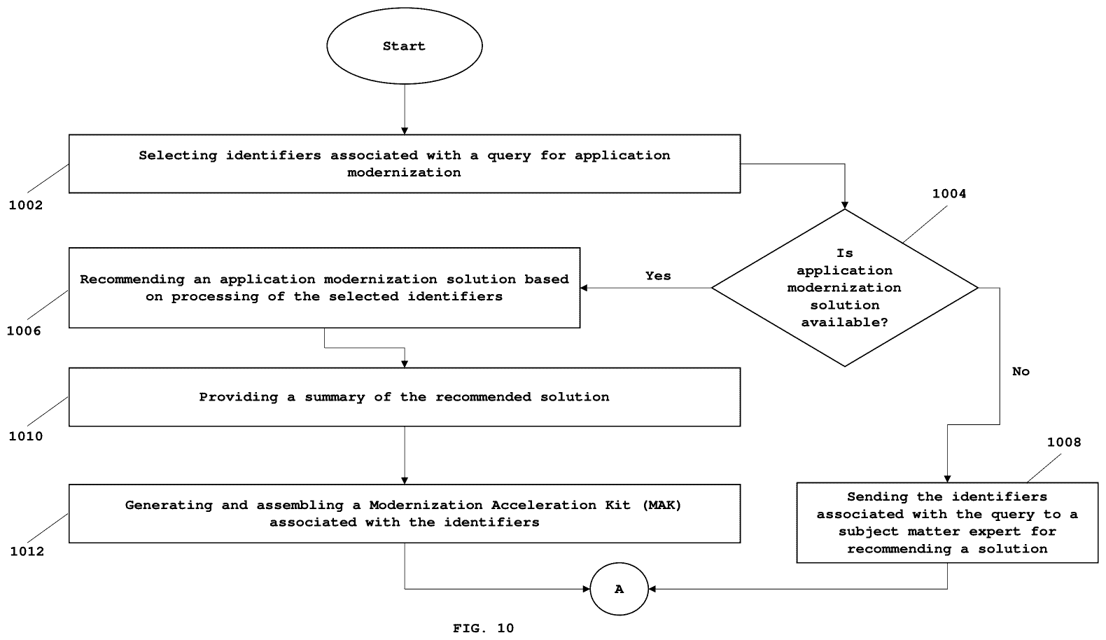

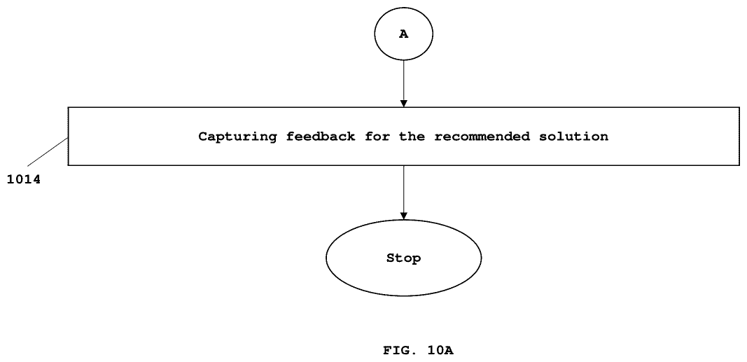

FIGS. 10 and 10A illustrate a method depicting for optimized modernization of applications, in accordance with various embodiments of the present invention.

At step 1002, identifiers associated with a query for application modernization are selected. In an embodiment of the present invention, an input is provided in the form of a query associated with the application modernization for carrying out the application modernization process. In an embodiment of the present invention, an authentication token is provided to the user device prior to carrying out the application modernization process. The directory server, which stores and maintains multiple users' data, is accessed for authorizing the user device to access the subsystem. In an embodiment of the present invention, a dynamic UI is rendered on the user device which provides a dashboard for capturing the query on the user device. The dashboard renders, on the UI, one or more pre-defined categories of application modernization and a list of technology stacks (tech stacks) based on a first set of pre-defined rules, for recommending appropriate application modernization solution. The pre-defined categories of application modernization include, but are not limited to, cloud migration, technology migration, technology upgrade and legacy application modernization. One of the categories from the four categories is selected at a time for application modernization according to users' needs and requirements. Further, the dashboard provides a list of technology stacks (tech stacks) on the UI from which a type of technology entity is selected for which modernization is required. The technology stack includes, but is not limited to, operating system, database, programing language, framework, middleware and scheduler. One of the technology stacks is selected via the UI. The selected pre-defined category and the technology stack is received as part of the query from the user device via the UI.

In an embodiment of the present invention, the query is processed for determining identifiers associated with the query. In an exemplary embodiment of the present invention, the query includes two identifiers for application modernization associated with user's needs and requirements. The two determined identifiers comprise a source technology selection and a target technology selection. The source technology selection represents a technology of an existing application and the target technology selection represents a new technology to which the existing application is to be migrated. For example, the source technology selection may relate to MS Access database management system and the target technology selection may relate to MySQL database management system.

In an embodiment of the present invention, a list of source technology and a list of target technology are sent for selection. The received lists are rendered via the UI based on an authentication process. In an exemplary embodiment of the present invention, the authentication process includes a single LDAP authentication. A source technology is selected from the list of source technology tags rendered on the UI. Further, the source technology tags are rendered along with their different versions and expiry dates. Furthermore, the target technology is selected from a list of target technology tags rendered on the UI. The target technology tags are rendered along with their different versions and expiry dates and most popular and latest target technology tags are rendered separately. In an embodiment of the present invention, prior to selection of the target technology, a compatibility check is carried out between the identifiers i.e. between the source technology and the target technology based on a pre-defined compatibility rule. For example, if MS Access v12 has been selected as a source technology, and MongoDB v6.2.1 has been selected as a target technology, then programming languages that are compatible with MongoDB v6.2.1 is selected as target technology. Further, the target technologies rendered on the UI must fulfill at least a compatibility criterion based on a pre-defined compatibility rule. The compatibility criterion includes but is not limited to, the target technology must not be expired and the target technology must be compatible with previously selected target technologies in order to ensure compatible environment.

At step 1004, a check is done to determine if application modernization solution is available. At step 1006, if application modernization solution is available, then an application modernization solution is recommended based on processing of the selected identifiers. In an embodiment of the present invention, the selected source technology and the target technology is further processed. A solution for application modernization is recommended based on a second set of pre-defined rules by analyzing the processed identifiers i.e. the source technology and the target technology. The recommended solution is rendered via the UI of the user device. The recommended solution is the application modernization solution, which may be an exact or a similar solution with respect to the target technology. Further, the recommended solution is provided along with a match percentage, which represents a percentage value of match for the recommended solution with respect to the source technology tag and the target technology tag. In an embodiment of the present invention, the second set of pre-defined rules identifies the modernization technologies based on technology equivalence and technology compatibility of the modernization technology with respect to an existing application technology. In an exemplary embodiment of the present invention, the technology equivalence is determined based on operational time period, generation and capabilities of a similar technology by using an equivalence relation incorporated in schema. Further, the technology compatibility is determined based on the compatibility relation of the modernization technology with respect to previously selected target technologies across one or more technology stacks by using the compatibility relation incorporated in the schema. For example, if a programming language modernization from Visual Basic v6 (source technology) to Java 7.1 (target technology) is selected, then a suitable solution is recommended as MongoDB v6.2.1 and one or more similar solutions, which is rendered via the UI. The compatibility relation enables to dynamically provide contextual solutions that are potentially relevant with user needs and requirements. The recommended solution may relate to application migration, database (DB) migration, operating system (OS) migration, programming language update, framework migration, hardware modifications, etc. Further, in the event it is determined that a DB migration is required, then the recommended solution also suggests an option to use a particular programing language for efficient migration. In an exemplary embodiment of the present invention, a first version type i.e. a lighter version of metadata related to various technologies is provided, which is processed for recommending the solution via the UI based on the analyzed source technology and the target technology. In another exemplary embodiment of the present invention, a second version type i.e. a larger version of the metadata is provided, which is further processed for recommending the solution via the UI based on the analyzed source technology and the target technology. In an exemplary embodiment of the present invention, the metadata associated with various technologies comprise various technology stacks, technology versions with end-of-support data, etc.

At step 1008, in the event it is determined that application modernization solution is not available, then the identifiers associated with the query are sent to a Subject Matter Expert (SME) for recommending a solution. In an embodiment of the present invention, an SME analyzes the selected source target technology and the target technology for recommending an appropriate solution. The solution recommended by the SME is rendered via the UI. The solution recommended by the SME is sent to a content repository for updating the content repository with the SME recommended solution.

At step 1010, a summary of the recommended solution is provided. In an embodiment of the present invention, a summary of the recommended solution is rendered based on a third set of pre-defined rules via the UI. In an exemplary embodiment of the present invention, the summary of the recommended solution comprises a brief description of the recommended solution, modernization phases, tools used, modifications made to the existing application during the modernization process such as, impact on the system, impact on databases, impact on features in database, impact on application, conversion mode, new function mode, application migration steps, etc. Further, each recommended solution is associated with a summary.

At step 1012, a Modernization Acceleration Kit (MAK) associated with the identifiers is generated and assembled. In an embodiment of the present invention, a downloadable Modernization Acceleration Kit (MAK) associated with the identifiers is assembled and generated based on a fourth set of pre-defined rules. The MAK comprises recommended solution summary, solution templates, details about ‘out of the box’ tools or accelerators and references. The MAK also comprises details on additional solution recommendations such as prerequisites and supplementary technology components and solutions that need to be considered. In another embodiment of the present invention, the MAK is contextualized based on constraints and customized to generate a solution blueprint for implementation. In an embodiment of the present invention, add-on MAKs are rendered via the UI based on one or more pre-defined questions. In another embodiment of the present invention, an option is provided to navigate across all relevant technology stacks to assemble associated solutions dynamically.

At step 1014, a feedback is captured for the recommended solution. In an embodiment of the present invention, the feedback is captured on effectiveness of the recommended solution via the user device. The feedback is used to regularly provide efficient solution recommendation.

Advantageously, in accordance with various embodiments of the present invention, an optimized modernization of applications by automatic dynamic solution recommendation is provided. The present invention provides for assembling the comprehensive solution without dependency on user or SME knowledge on solution dependencies or assembly pre-requisites. The present invention provides for a self-healing and an elastic system that efficiently recommends modernization solutions which are regularly updated. The present invention provides for a dynamic solution recommendation based on continuous SME feedback. Further, the present invention provides for a scalable and extendable MAKs which can be added iteratively on the platform without any application changes or downtime. The present invention provides a clear visualization of accelerators and differentiators involved in the application migration process. Also, the present invention provides for unified techniques used for modernizing of the applications. The present invention provides for cross-stack impact of one technology on the other while carrying out modernization of the applications. Further, the present invention provides for a robust modernization of applications, which caters to user's needs and requirements. Furthermore, the present invention provides for a comprehensive compatibility of data across all relevant technology stacks, thereby eliminating user awareness dependency to construct the solution. Yet further, the present invention provides for a system which renders all the relevant technology stacks to the user which are assembled dynamically. Furthermore, the present invention provides for a highly extendable and configurable UI, which allows navigation through various solutions and visualization of an end-to-end comprehensive, multi-dimensional solution. Also, the present invention provides for identifying and recommending suitable compatible solutions that can be part of any technology assessment. Yet further, the preset invention provides for a system that is easily scalable and can be updated with new rules.

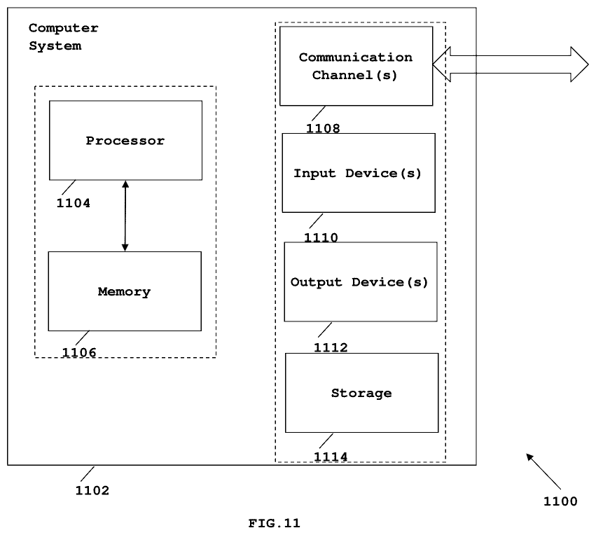

FIG. 11 illustrates an exemplary computer system in which various embodiments of the present invention may be implemented. The computer system 1102 comprises a processor 1104 and a memory 1106. The processor 1104 executes program instructions and is a real processor. The computer system 1102 is not intended to suggest any limitation as to scope of use or functionality of described embodiments. For example, the computer system 1102 may include, but not limited to, a programmed microprocessor, a micro-controller, a peripheral integrated circuit element, and other devices or arrangements of devices that are capable of implementing the steps that constitute the method of the present invention. In an embodiment of the present invention, the memory 1106 may store software for implementing various embodiments of the present invention. The computer system 1102 may have additional components. For example, the computer system 1102 includes one or more communication channels 1108, one or more input devices 1110, one or more output devices 1112, and storage 1114. An interconnection mechanism (not shown) such as a bus, controller, or network, interconnects the components of the computer system 1102. In various embodiments of the present invention, operating system software (not shown) provides an operating environment for various softwares executing in the computer system 1102, and manages different functionalities of the components of the computer system 1102.

The communication channel(s) 1108 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, Bluetooth or other transmission media.

The input device(s) 1110 may include, but not limited to, a keyboard, mouse, pen, joystick, trackball, a voice device, a scanning device, touch screen or any another device that is capable of providing input to the computer system 1102. In an embodiment of the present invention, the input device(s) 1110 may be a sound card or similar device that accepts audio input in analog or digital form. The output device(s) 1112 may include, but not limited to, a user interface on CRT or LCD, printer, speaker, CD/DVD writer, or any other device that provides output from the computer system 1102.

The storage 1114 may include, but not limited to, magnetic disks, magnetic tapes, CD-ROMs, CD-RWs, DVDs, flash drives or any other medium which can be used to store information and can be accessed by the computer system 1102. In various embodiments of the present invention, the storage 1114 contains program instructions for implementing the described embodiments.

The present invention may suitably be embodied as a computer program product for use with the computer system 1102. The method described herein is typically implemented as a computer program product, comprising a set of program instructions which is executed by the computer system 1102 or any other similar device. The set of program instructions may be a series of computer readable codes stored on a tangible medium, such as a computer readable storage medium (storage 1114), for example, diskette, CD-ROM, ROM, flash drives or hard disk, or transmittable to the computer system 1102, via a modem or other interface device, over either a tangible medium, including but not limited to optical or analogue communications channel(s) 1108. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as a system, a method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the scope of the invention.

We claim:

1. A system for optimized modernization of applications, the system comprising:
a memory storing programing instructions;
a processor executing the program instructions stored in the memory; and
an application modernization engine executed by the processor and configured to:
receive one or more pre-defined categories of application modernization and technology stacks as a query, wherein the pre-defined categories of application modernization and technology stacks are rendered via a user interface (UI) based on a first set of pre-defined rules;
determine application modernization identifiers associated with the query, wherein a compatibility check is carried out between the identifiers based on a pre-defined compatibility rule;
recommend a solution for application modernization based on a second set of pre-defined rules by analyzing the identifiers; and
generate a Modernization Acceleration Kit (MAK) associated with the identifiers based on the recommended solution for implementation of the recommended solution for optimized modernization of the application.

2. The system as claimed in claim 1, wherein the application modernization engine comprises a web server unit and an authentication server unit executed by the processor, the web server unit is configured to communicate with the authentication server unit prior to receiving the query, for receiving an authentication token for a user device for accessing the application modernization engine, and wherein the authentication server unit is configured to communicate with a directory server, which stores and maintains multiple users' data, for authorizing the user device to access the application modernization engine.

3. The system as claimed in amended claim 2, wherein the web server unit is configured to render a dynamic user interface (UI) on the user device including a dashboard for capturing the query on the user device, and wherein the dashboard on the UI renders the pre-defined categories of application modernization and a list of the technology stacks.

4. The system as claimed in amended claim 1, wherein the pre-defined categories of application modernization include cloud migration, technology migration, technology upgrade and legacy modernization, and wherein the technology stacks include an operating system, a database, a programing language, a framework, a middleware and a scheduler.

5. The system as claimed in claim 1, wherein the application modernization engine comprises an Application programming Interface (API) server unit executed by the processor and configured to receive the query from a web server unit, and analyzes the query for determining identifiers associated with the query.

6. The system as claimed in claim 1, wherein the query includes two identifiers for application modernization associated with user's needs and requirements, wherein the two identifiers comprise a source technology selection and a target technology selection, the source technology selection represents technology of an existing application and the target technology selection represents a new technology into which the existing application needs to be migrated.

7. The system as claimed in claim 1, wherein the application modernization engine comprises a content repository executed by the processor and configured to send a list of source technology tags and a list of target technology tags, via a web content management server unit, for selection to a web server unit, wherein the source technology tags are rendered along with different versions and expiry dates, and wherein the target technology tags are rendered along with different versions and expiry dates, and most popular and latest target technology tags are rendered separately.

8. The system as claimed in claim 1, wherein the recommended solution is fetched by a web content management server unit from a content repository for rendering on a user device, and wherein the recommended solution is an application modernization solution which is an exact or a similar solution with respect to a target technology.

9. The system as claimed in claim 8, wherein the recommended solution is provided along with a match percentage representative of a percentage value of match for the recommended solution with respect to a source technology tag and a target technology tag.

10. The system as claimed in claim 1, wherein the second set of pre-defined rules includes identifying modernization technologies included in the query based on technology equivalence and technology compatibility of the modernization technology with respect to an existing application technology, and wherein the technology equivalence is determined based on operational time period, generation and capabilities of a similar technology by using an equivalence relation incorporated in a schema, and wherein the technology compatibility is determined based on a compatibility relation of the modernization technology with respect to previously selected target technologies across one or more technology stacks by using a compatibility relation incorporated in the schema.

11. The system as claimed in claim 1, wherein the recommended solution relates to application migration, database (DB) migration, operating system (OS) migration, programming language update, framework migration and hardware modifications.

12. The system as claimed in claim 8, wherein the content repository is configured with a first version type of metadata related to various technologies which is processed by the web content management server unit for recommending the solution via the UI based on the source technology and the target technology, and wherein a My SQL DB associated with the application modernization engine is configured with a second version type of the metadata which is processed for recommending the solution via the UI based on the source technology and the target technology.

13. The system as claimed in claim 1, wherein application modernization engine generates a summary of the recommended solution based on a third set of pre-defined rules, the third set of pre-defined rules includes generating a summary comprising one or more of a brief description of the recommended solution, modernization phases, tools used, modifications made to the existing application during the modernization process such as, impact on the system, impact on databases, impact on features in database, impact on application, conversion mode, new function mode and application migration steps.

14. The system as claimed in claim 1, wherein a web content management server unit in communication with the content repository provides for assembling and generating the MAK associated with the identifiers based on a fourth set of pre-defined rules for implementation of the solution, the MAK being downloadable, and wherein the MAK is contextualized based on constraints and customized to generate a solution blueprint for implementation of the recommended solution.

15. The system as claimed in claim 8, wherein the web content management server unit in communication with the content repository provides an option to navigate across all relevant technology stacks to assemble associated solutions dynamically.

16. The system as claimed in claim 8, wherein in the event the web content management server unit is not able to recommend a solution for the selected source target technology and the target technology, then the web content management server unit creates a ‘no solution’ entry in the content repository and communicates the selected source target technology and the target technology to a Subject Matter Expert (SME) for solution generation.

17. The system as claimed in claim 1, wherein the application modernization engine comprises a feedback capturing unit executed by the processor and configured to capture feedback related to effectiveness of the recommended solution via a user device, and wherein the feedback capturing unit is configured to communicate with a web content management server unit for transmitting the feedback for storage in a content repository for the web content management server unit to regularly provide an efficient solution recommendation.

18. A method for optimized modernization of applications, the method comprising:
receiving, via a processor, one or more pre-defined categories of application modernization and technology stacks as a query, wherein the pre-defined categories of application modernization and technology stacks are rendered via a user interface (UI) based on a first set of pre-defined rules;
determining, via the processor, application modernization identifiers associated with the query, wherein a compatibility check is carried out between the identifiers based on a pre-defined compatibility rule;
recommending, via the processor, a solution for application modernization based on a second set of pre-defined rules by analyzing the identifiers; and
generating, via the processor, a Modernization Acceleration Kit (MAK) associated with the identifiers based on the recommended solution for implementation of the recommended solution for optimized modernization of the application.

19. The method as claimed in claim 18, wherein an authentication token is provided to a user device, on which the UI is rendered, for accessing the application modernization engine for carrying out the optimized application modernization.

20. The method as claimed in claim 19, wherein the UI is a dynamic UI and provides a dashboard for capturing the query on the user device, and wherein the dashboard on the UI renders one or more pre-defined categories of the application modernization and a list of the technology stacks.

21. The method as claimed in claim 18, wherein the pre-defined categories of application modernization include cloud migration, technology migration, technology upgrade and legacy modernization, and wherein the technology stacks include an operating system, a database, a programing language, a framework, a middleware and a scheduler.

22. The method as claimed in claim 1, wherein the query is processed for determining identifiers associated with the query.

23. The method as claimed in claim 18, wherein the query includes two application modernization identifiers associated with user's needs and requirements, and wherein the two identifiers comprise a source technology selection and a target technology selection, and wherein the source technology selection represents technology of an existing application and the target technology selection represents a new technology in which the existing application is to be migrated.

24. The method as claimed in claim 23, wherein a list of source technology tags and a list of target technology tags are rendered via the UI for selection based on an authentication process, and wherein the source technology tags are rendered along with different versions and expiry dates, and wherein the target technology tags are rendered along with different versions and expiry dates, and most popular and latest target technology tags are rendered separately.

25. The method as claimed in claim 18, wherein the recommended solution is an application modernization solution which is an exact or a similar solution with respect to a target technology.

26. The method as claimed in claim 25, wherein the recommended solution is provided along with a match percentage which represents a percentage value of match for the recommended solution with respect to the source technology tag and the target technology tag.

27. The method as claimed in claim 18, wherein the second set of pre-defined rules identifies the modernization technologies based on technology equivalence and technology compatibility of the modernization technology with respect to an existing application technology, and wherein the technology equivalence is determined based on operational time period, generation and capabilities of a similar technology by using an equivalence relation incorporated in schema, and wherein the technology compatibility is determined based on a compatibility relation of the modernization technology with respect to a previously selected target technologies across one or more technology stacks by using the compatibility relation incorporated in the schema.

28. The method as claimed in claim 18, wherein the recommended solution relates to application migration, database (DB) migration, operating system (OS) migration, programming language update, framework migration and hardware modifications.

29. The method as claimed in claim 25, wherein a first version type of metadata related to various technologies is processed for recommending the solution via the UI based on a source technology and a target technology, and wherein a My SQL DB is configured with a second version type of the metadata which is processed for recommending the solution via the UI based on the source technology and the target technology.

30. The method as claimed in claim 18, wherein a summary associated with the recommended solution is generated based on a third set of pre-defined rules, the third set of predefined rules comprises generating the summary comprising one or more of a brief description of the recommended solution, modernization phases, tools used, modifications made to the existing application during the modernization process such as, impact on the system, impact on databases, impact on features in database, impact on application, conversion mode, new function mode and application migration steps.

31. The method as claimed in claim 18, wherein the MAK is assembled and generated based on a fourth set of pre-defined rules, and wherein the MAK is contextualized based on constraints and customized to generate a solution blueprint for implementation of the recommended solution.

32. The method as claimed in claim 18, wherein a feedback is captured related to effectiveness of the recommended solution via the user device, and wherein the feedback is used for regularly providing an efficient solution recommendation.

33. A computer program product comprising:
a non-transitory computer-readable medium having computer program code stored thereon, the computer-readable program code comprising instructions that, when executed by a processor, causes the processor to:
receive one or more pre-defined categories of application modernization and technology stacks as a query, wherein the pre-defined categories of application modernization and technology stacks are rendered via a user interface (UI) based on a first set of pre-defined rules;
determine application modernization identifiers associated with the query, wherein a compatibility check is carried out between the identifiers based on a pre-defined compatibility rule;
recommend a solution for application modernization based on a second set of pre-defined rules by analyzing the identifiers; and
generate a Modernization Acceleration Kit (MAK)associated with the identifiers based on the recommended solution for implementation of the recommended solution for optimized modernization of the application.
